(19) United States
(12) Patent Application Publication
(10) Pub. No.: US 2025/0297635 A1
(43) Pub. Date: Sep. 25, 2025

(54) BOLT FOR STRESS REDUCTION

(71) Applicant: International Truck Intellectual Property Company, LLC, Lisle, IL (US)

(72) Inventors: Roberto Vallejo, Woodridge, IL (US); Jose Israel Landeros Mendoza, Aurora, IL (US)

(73) Assignee: International Truck Intellectual Property Company, LLC, Lisle, IL (US)

(21) Appl. No.: 18/611,958

(22) Filed: Mar. 21, 2024

(51) Int. Cl. F16B 35/04; F16B 33/00; F16B 35/06

(52) U.S. Cl. CPC F16B 35/041; F16B 33/002; F16B 35/06

(57) ABSTRACT

A bolt for stress reduction between strap loop applications is provided for reducing stress between strap applications using a novel bolt design. The bolt for stress reduction between strap loop applications may include a head, body, body shank portion, chamfered segment and body threaded portion. The strap may interact with multiple points of contact of the novel bolt to reduce concentration of stress, which may reduce the likelihood of failure. The head is configured to reduce undesired rotation, such that the bolt will remain in the desired position during operation.

### FIELD OF THE INVENTION

The present disclosure relates to a bolt for stress reduction between strap loop applications. More particularly, the disclosure relates to reducing stress between strap loop applications using a novel bolt design.

### BACKGROUND

Bolts play a central role in various mechanical devices. More particularly, bolts hold components in a desired location, for example, in a combustion engine. However, when a bolt is used in high tension applications, for example, when a strap is placed around the bolt, the item holding the tension can become prone to breaking due to the massive force placed on the item at a singular contact point. This is problematic for those skilled in the art because it often leads to delays in testing, manufacturing, or obstructions to daily usage. Broken belts may additionally contribute to increases in service and maintenance costs.

What is needed is an applicably shaped bolt to assist in withstanding various tests and requirements in automotive application. What is needed is a bolt with a body designed to maximize surface area contact with regard to loop straps. What is needed is a bolt with a head to prevent undesired rotation when fixed to a support.

### SUMMARY

An aspect of the disclosure provides an applicably shaped bolt to assist in withstanding various tests and requirements in automotive application. An aspect of the disclosure provides a bolt with an originally designed body to maximize surface area contact with regard to loop straps. An aspect of the disclosure provides a bolt with a head to prevent undesired rotation when fixed to a support.

Accordingly, the disclosure may feature a bolt provided to reduce undesired rotation and to increase contact surface including a head and a body. The head may include a top head surface bounded by a rounded head edge and at least one straight head edge. The body may extend outwardly from the head, including a body shank portion and a body threaded portion. The body shank portion may extend outwardly from a bottom head surface of the head. The body shank portion may include a chamfered segment being substantially planar. The body threaded portion may extend outwardly from the body shank portion.

In another aspect, the head may further include a curved front head side proximate to the rounded head edge. The head may further include a first linear head side adjacent to the curved front head side. The head may further include a second linear head side adjacent to the curved front head side and opposite of the first linear head side. The head may further include a rear linear head side located between the first linear head side and the second linear head side. The rear linear head side may be located opposite of the curved front head side.

In another aspect, a rear head plane provided by the rear linear head side, a first head plane provided by the first linear head side, and a second head plane provided by the second linear head side may be nonparallel.

In another aspect, a rear head plane provided by the rear linear head side may be nonparallel to a receiving plane provided by the chamfered segment.

In another aspect, the chamfered segment and at least part of the curved front head side may face a first direction.

In another aspect, a rear head plane provided by the rear linear head side and a receiving plane provided by the chamfered segment may be askew.

In another aspect, the body shank portion may include cylindrical shank segments which may be located between the head and the body threaded portion. The cylindrical shank segment may transition to the chamfered segment via chamfered edges.

In another aspect, the top head surface may be substantially flat.

In another aspect, a top head plane provided by the top head surface may be orthogonal to a receiving plane provided by the chamfered segment.

In another aspect, the threaded portion may be M16 thread size.

In another aspect, the bolt may be manufactured with materials including medium carbon steel, medium carbon steel alloy, and/or low carbon boron steel.

In another aspect, the chamfered segment may be configured to increase the contact surface area which may receive an aftertreatment strap within an internal combustion engine.

Accordingly, the disclosure may feature a bolt provided to reduce undesired rotation and to increase contact surface area including a head and a body. The head may include a top head surface bounded by a rounded head edge and at least one straight head edge. The body may include a body shank portion and a body threaded portion. The body shank portion may extend outwardly from a bottom head surface of the head including a chamfered segment being substantially planar. The body shank portion may further include cylindrical shank segments located between the head and the body threaded portion. The cylindrical shank segments may transition to the chamfered segment via chamfered edges. The body threaded portion may extend outwardly from the body shank portion. The body shank portion may be longer than the body threaded portion.

In another aspect, the head may further include a curved front head side proximate to the rounded head edge. The head may further include a first linear head side adjacent to the curved front head side. The head may further include a second linear head side adjacent to the curved front head side and opposite of the first linear head side. The head may further include a rear linear head side located between the first linear head side and the second linear head side. The rear linear head side may be located opposite of the curved front head side.

In another aspect, a rear head plane provided by the rear linear head side, a first head plane provided by the first linear head side, and a second head plane provided by the second linear head side may be nonparallel.

In another aspect, a rear head plane provided by the rear linear head side may be nonparallel to a receiving plane provided by the chamfered segment.

In another aspect, the chamfered segment and at least part of the curved front head side may face a first direction.

In another aspect, a rear head plane provided by the rear linear head side and the receiving plane provided by the chamfered segment may be askew.

In another aspect, a top head plane provided by the top head surface may be orthogonal to a receiving plane provided by the chamfered segment.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, and aspects described by this disclosure will become more apparent from the following detailed description, along with the accompanying drawings in which like numerals represent like components.

### BRIEF DESCRIPTION OF THE DRAWINGS

FIG. 1 is a perspective view of a bolt, according to an embodiment of this disclosure.

FIG. 2 is a side elevation view of a bolt, according to an embodiment of this disclosure.

FIG. 3 is a rear elevation view of a bolt, according to an embodiment of this disclosure.

FIG. 4 is a front elevation view of a bolt, according to an embodiment of this disclosure.

FIG. 5 is a cross-sectional bottom plan view of a bolt, according to an embodiment of this disclosure.

FIG. 6 is a bottom plan view of a bolt, according to an embodiment of this disclosure.

FIG. 7 is a perspective view of a bolt interacting with aftertreatment straps, according to an embodiment of this disclosure.

FIG. 8 is a bottom plan view of a bolt interacting with aftertreatment straps, according to an embodiment of this disclosure.

FIG. 9 is a perspective view of a bolt installed to an internal combustion engine for operational context, according to an embodiment of this disclosure.

### DETAILED DESCRIPTION

The following disclosure is provided to describe various embodiments of a bolt for stress reduction between loop strap and other applications. Skilled artisans will appreciate additional embodiments and uses of bolts as described herein that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term bolt, as it is used throughout this disclosure, is defined as a rod or pin for fastening objects together or for holding objects in place, usualy being secured by a nut. The term adjacent, as it is used throughout this disclosure, is defined as having a common endpoint or border. The term face, as it is used throughout this disclosure, is defined as being configured in a certain direction. The term segment, as it is used throughout this disclosure, is defined as a two or three dimensional portion of an object. The term edge, as it is used throughout this disclosure, is defined as the line where two nonparallel planes generally meet. The term shank, as it is used throughout this disclosure, is defined as the part of a body of a bolt which is not threaded. The term chamfered, as it is used throughout this disclosure, is defined as a non-linear edge, including tapered, beveled, and rounded. The term midline, as it is used throughout this disclosure, is defined as an imaginary line used to locate the center of an object, usually a median line.

Various aspects of the present disclosure will now be described in detail, without limitation. In the following disclosure, a bolt for stress reduction between loop strap applications will be discussed. Those of skill in the art will appreciate alternative labeling of the bolt for stress reduction between loop strap applications as a rotation resistant bolt, bolt for fatigue and stress mitigation, enhanced surface area bolt, or other similar names. Skilled readers should not view the inclusion of any alternative labels as limiting in any way.

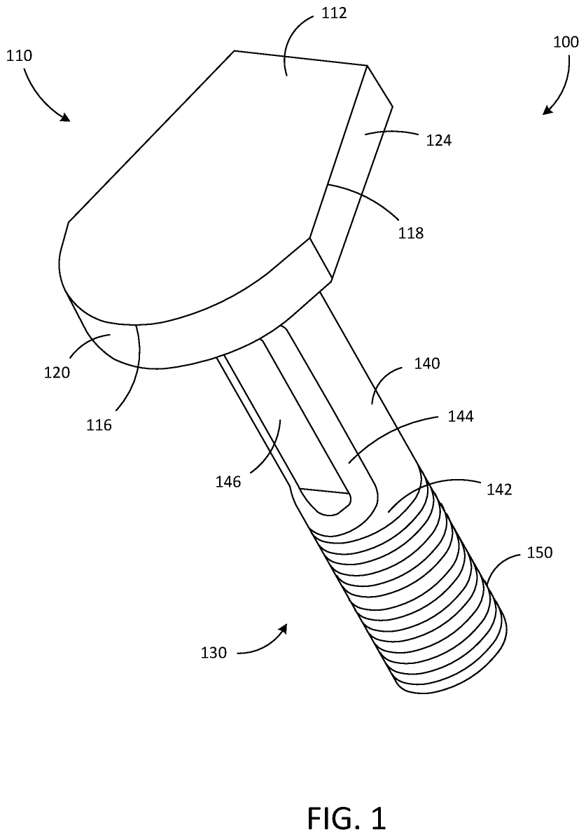

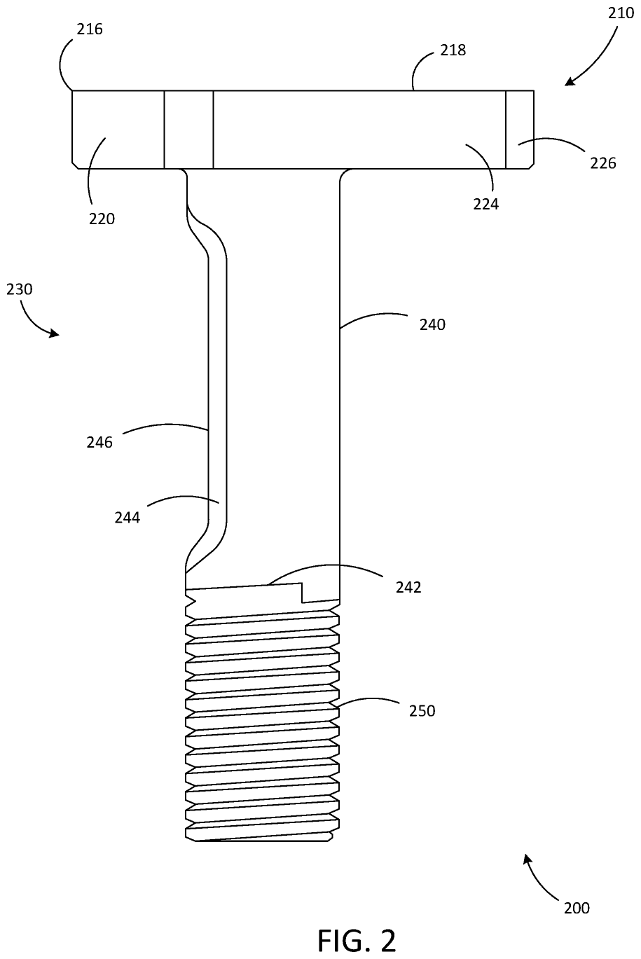

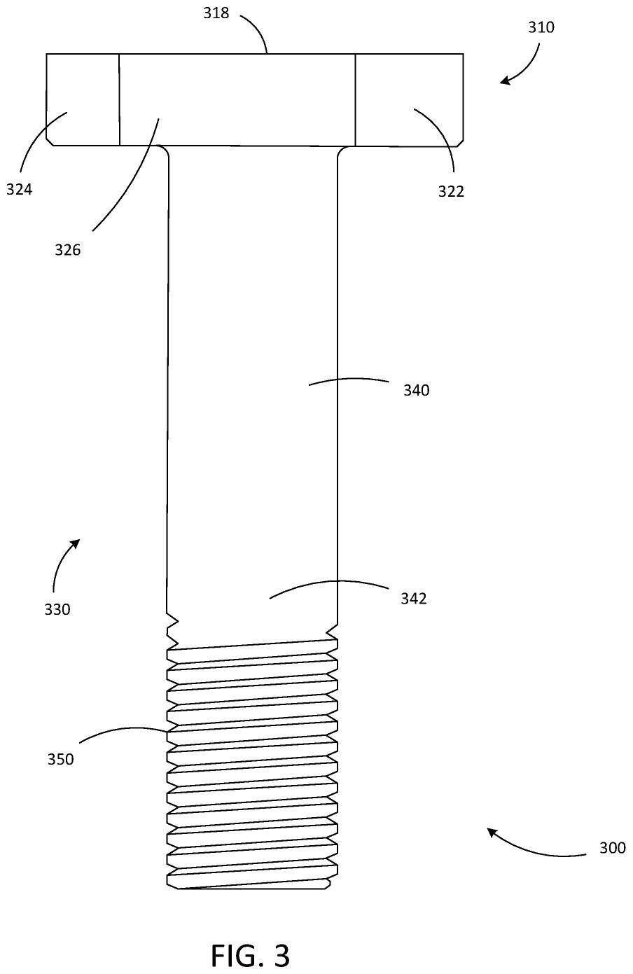

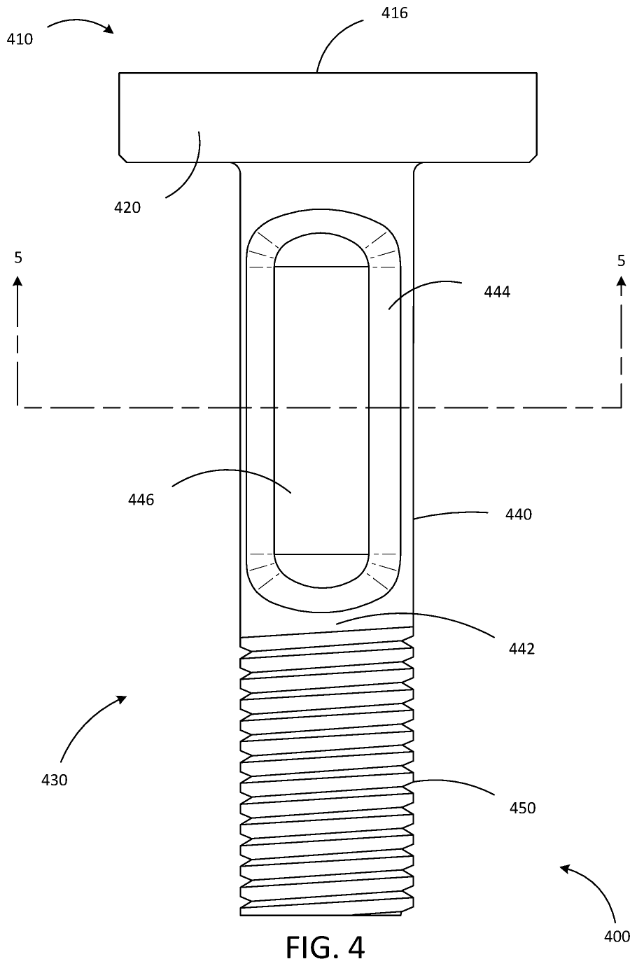

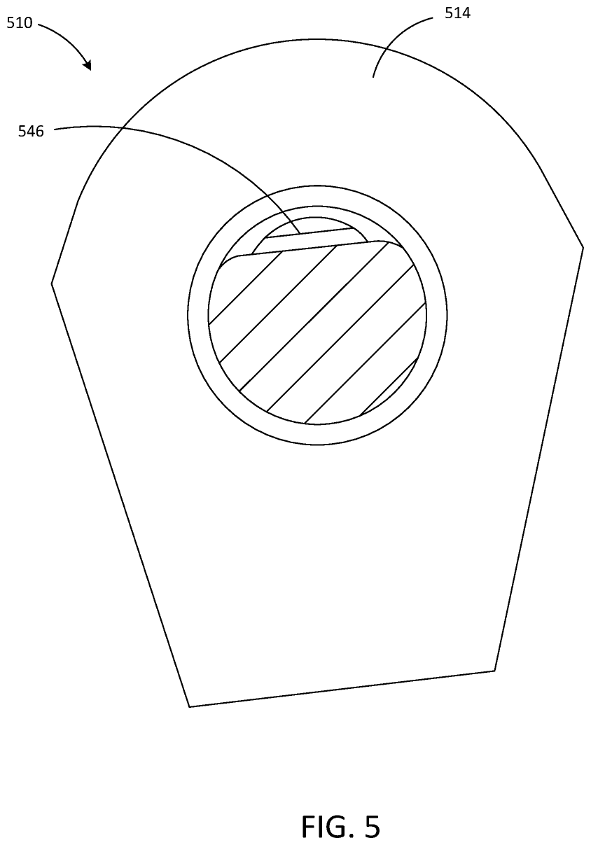

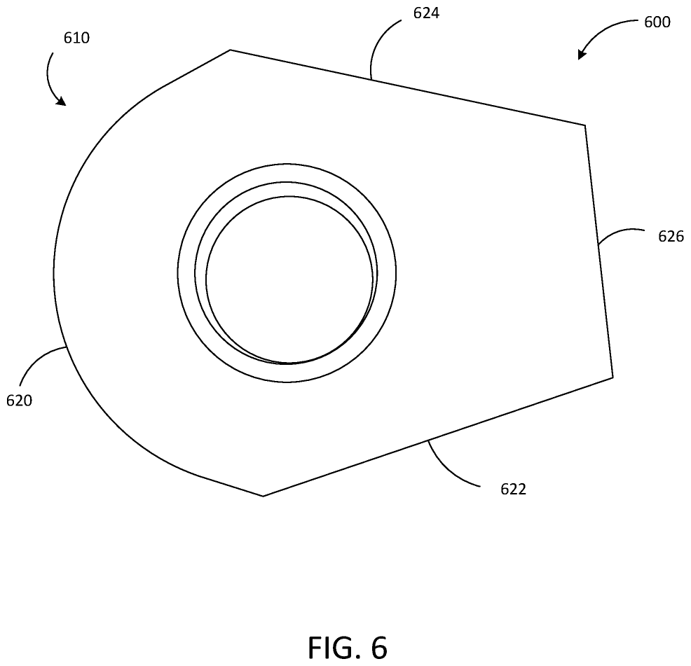

Referring now to FIGS. 1-9, the bolt for stress reduction between strap loop applications will now be discussed in more detail. The bolt for stress reduction between strap loop applications may include a head, body, body shank portion, chamfered segment, cylindrical shank segment, body threaded portion, and additional components that will be discussed in greater detail below. The bolt for stress reduction between strap loop applications may operate one or more of these components interactively with other components for reducing stress between strap applications using a novel bolt design.

The head 110, 210, 310, 410, 510, 610 will now be discussed in greater detail. FIGS. 1-7 and 9 highlight examples of the head 110, 210, 310, 410, 510, 610, which may also be shown in other figures.

The head 110, 210, 310, 410, 510, 610, enabled by this disclosure, may comprise multiple head surfaces. These head surfaces may be a top head surface 112, 712, 912 and a bottom head surface 514. An embodiment may include the top head surface 112, 712, 912 and the bottom head surface 514 being formed of different shapes and sizes. Those skilled in the art will appreciate the various shapes and sizes the top head surface 112, 712, 912 and the bottom head surface 514 may be configured as. In one embodiment, the top head surface 112, 712, 912 and the bottom head surface 514 may be of the same shape and size.

The head surfaces may take on different forms. In one embodiment, the top head surface 112, 712, 912 may be substantially planar. In another embodiment, the bottom head surface 514 may be substantially planar everywhere except for the location where the body 130, 230, 330, 430 extends outward from the bottom head surface 514. In another embodiment, the head surfaces may be curved. Those skilled in the art will appreciate the various two-dimensional or three-dimensional shapes the head surfaces may take on. In an embodiment, the head surfaces may further include one or more notches to support the use of various tools. Those skilled in the art will appreciate the various notches and divots the head surfaces may have.

The head surfaces may be bound by at least one head edge. The head edge may be rounded, straight, wavy, or zigzag-like. Those skilled in the art will appreciate the various forms a head edge may be. In one embodiment, the head surfaces may further be bounded by at least one rounded head edge 116, 216, 416 and at least one straight head edge 118, 218, 318.

In another embodiment, the head surfaces may be bounded by one rounded head edge 116, 216, 416 and three straight head edges. Those skilled in the art will appreciate the multiple combinations one can make for a different number of rounded head edges and a different number of straight head edges.

The head 110, 210, 310, 410, 510, 610 may further include the head sides. The head sides may act as connection surfaces between the head surfaces via the head edges. The number of head sides may correspond with the number of head edges. Those skilled in the art, however, will appreciate that numerous head sides may be located on the head.

In one embodiment, the top head surface 112, 712, 912 may be connected to the bottom head surface 514 via a curved front head side 120, 220, 420, 620, a first linear head side 322, 622, a second linear head side 124, 224, 324, 624, and a rear linear head side 226, 326, 626. Similarly to the head edges, the head sides may be present in different forms, including, but not limited to, a straight plane, a curved plane, or a wavy plane. Those skilled in the art will appreciate the various planes a head side may exist in.

The curved front head side 120, 220, 420, 620 may be attached to the rounded head edge 116, 216, 416 of the top head surface 112, 712, 912. Those skilled in the art will appreciate the different angular measurements of the curved front head side from one end of the curved front head side to another opposite end of the curved front head side. In one embodiment, the curved front head side 120, 220, 420, 620 may have an angular measurement between 90 degrees −180 degrees. A distance from one end of the curved front head side 120, 220, 420, 620 to an opposite end of the curved front head side 120, 220, 420, 620 may be taken. Those skilled in the art will appreciate the varied distances between the aforementioned two ends. Those skilled in the art will also appreciate the variability of manufacturing such a product, thus, a distance may be given as a range of values rather than one value. In one embodiment that distance may be between 39.3 mm −39.5 mm, without limitation.

The straight head side may be attached to each end of the curved front head side 120, 220, 420, 620. Those skilled in the art will appreciate that multiple straight head sides may be affixed together to make up the head. In one embodiment, three straight head sides and a curved front head side 120, 220, 420, 620 comprise the bolt head 110, 210, 310, 410, 510, 610. The three straight head sides may be the first linear head side 322, 622, the second linear head side 124, 224, 324, 624, and the rear linear head side 226, 326, 626.

In one embodiment, the curved front head side 120, 220, 420, 620 may be adjacent to the first linear head side 322, 622; the first linear head side 322, 622 may be adjacent to the rear linear head side 226, 326, 626; the rear linear head side 226, 326, 626 may be adjacent to the second linear head side 124, 224, 324, 624; and/or the second linear head side 124, 224, 324, 624 may be adjacent to the curved front head side 120, 220, 420, 620. In the same or different embodiment, the curved front head side 120, 220, 420, 620 may be located opposite to the rear linear head side 226, 326, 626. Further, in the same or different embodiment, the first linear head side 322, 622 may be located opposite to the second linear head side 124, 224, 324, 624.

The straight head sides may be different lengths. Those skilled in the art will appreciate the various lengths of each straight head side. One or more of the straight head sides may be the same length, while other straight head sides may be of different lengths. In one embodiment, the first linear head side 322, 622, the second linear head side 124, 224, 324, 624, and the rear linear head side 226, 326, 626 may be a different length. In one embodiment, the rear linear head side 226, 326, 626 may be a smaller length than the length of the first linear head side 322, 622 and/or the length of the second linear head side 124, 224, 324, 624. In another embodiment, provided without limitation, the first linear head side 322, 622 and the second linear head side 124, 224, 324, 624 may be the same length, while the rear linear head side 226, 326, 626 may be a different length. In one embodiment, the rear linear head side 226, 326, 626 may be a smaller length than the length of the first linear head side 322, 622 and/or the length of the second linear head side 124, 224, 324, 624. Those skilled in the art will appreciate the numerous lengths of the head sides that may be provided after having the benefit of this disclosure.

Each head side may provide one or more planes. The planes provided by each straight head side may be parallel or may be nonparallel to each other. In one embodiment, each plane provided by each straight head side may be nonparallel, for example, a first head plane provided by the first linear head side 322, 622, a second head plane provided by the second linear head side 124, 224, 324, 624, and a rear head plane provided by the rear linear head side 226, 326, 626, all of which may all be nonparallel to one another. Those skilled in the art will appreciate the numerous variations one could make between the sides and their parallelism.

Various other measurements from one point located on the head 110, 210, 310, 410, 510, 610 to another point located on the head 110, 210, 310, 410, 510, 610 may be taken. These measurements may be helpful for manufacturing purposes and are given in the following examples without limitation. In one embodiment, the measurement of the length of the rear linear head side 226, 326, 626 may be between about 22.50 mm-22.70 mm. In this or another embodiment, the measurement from the intersection of the second linear head side 124, 224, 324, 624 and the rear linear head side 226, 326, 626 to the most distal point of the curved front head side 120, 220, 420, 620 may be between about 48.9 mm-49.1 mm. In this or another embodiment, the measurement from the intersection of the first linear head side 322, 622 and the rear linear head side 226, 326, 626 to the most distal point of the curved front head side 120, 220, 420, 620 may be between about 46.60 mm-46.80 mm. In various embodiments, the radius of the rounded head edge 116, 216, 416 may be between about 18.98 mm-19.02 mm. Those skilled in the art will appreciate the virtually unlimited measurements that one may take regarding the head of the bolt after having the benefit of this disclosure.

The angular measurement from a first head plane provided by the first linear head side 322, 622 and a second head plane provided by the second linear head side 124, 224, 324, 624 may be taken. Those skilled in the art will appreciate various additional angular measurements between these two planes may be provided, without limitation. In another embodiment, the angular measurement between the first head plane provided by the first linear head side 322, 622 and the second head plane provided by the second linear head side 124, 224, 324, 624 in comparison to the angular measurement of the curved front head side 120, 220, 420, 620 may not be the same. In one embodiment, the angular measurement between a first head plane provided by the first linear head side 322, 622 and a second head plane provided by the second linear head side 124, 224, 324, 624 may be approximately 31 degrees. Those skilled in the art will appreciate the various additional angular measurements that the planes provided by the head sides may make with one another may be used, without limitation.

The thickness of the head 110, 210, 310, 410, 510, 610 may be the distance between the top head surface 112, 712, 912 and the bottom head surface 514. In one embodiment, the thickness of the head 110, 210, 310, 410, 510, 610 may be approximately 8 mm. Those skilled in the art will appreciate the varied thicknesses of the head to fit a particular space the bolt will be installed to may be otherwise configured, without limitation.

The body 130, 230, 330, 430 will now be discussed in greater detail. FIGS. 1-9 highlight examples of the body 130, 230, 330, 430, which may also be shown in other figures. The body 130, 230, 330, 430 may be located adjacent to the head 110, 210, 310, 410, 510, 610. In one embodiment, the body 130, 230, 330, 430 may extend outwardly from the head 110, 210, 310, 410, 510, 610. In other embodiments, the body 130, 230, 330, 430 may be coupled to the head 110, 210, 310, 410, 510, 610. Those skilled in the art will appreciate the unlimited variations in which the head may generally be near or adjacent to the body. In other embodiments, there may be other sections of the bolt 100, 200, 300, 400, 600, 700 between the head 110, 210, 310, 410, 510, 610 and the body 130, 230, 330, 430, wherein the body 130, 230, 330, 430 may be indirectly connected to the head 110, 210, 310, 410, 510, 610.

In one embodiment, the body 130, 230, 330, 430 may extend outwardly from the bottom head surface 514. In another embodiment, the body 130, 230, 330, 430 may extend outwardly from the top head surface 112, 712, 912. Those skilled in the art will appreciate the endless variation of locations in which the body may be located at.

In various embodiments, the edge between the body 130, 230, 330, 430 and the head 110, 210, 310, 410, 510, 610 may be comprised of a chamfered edge, a fillet edge, a 90-degree edge, a bevel edge, a bullnose edge, and/or an eased edge. Those skilled in the art will appreciate the endless variations of edges between the body and the head.

In some embodiments, the body 130, 230, 330, 430 and the head 110, 210, 310, 410, 510, 610 may be comprised of the same material. In various embodiments, this material may be comprised of class 10.9, MPAPS F-31, Part 1 material. In other embodiments, the body 130, 230, 330, 430 and the head 110, 210, 310, 410, 510, 610 may be manufactured with materials, comprising medium carbon steel, medium carbon steel allow, and/or low carbon boron steel. In other embodiments, the body 130, 230, 330, 430 may be comprised of one material, while the head 110, 210, 310, 410, 510, 610 may be comprised of a different material. Those skilled in the art will appreciate the variation of materials and manufacturing processes in which the body and head may be comprised.

In general, the body 130, 230, 330, 430 may comprise a body threaded portion 150, 250, 350, 450 and a body shank portion 140, 240, 340, 440. In certain embodiments, the body 130, 230, 330, 430 may only comprise a body threaded portion 150, 250, 350, 450, while in other embodiments, the body 130, 230, 330, 430 may only comprise a body shank portion 140, 240, 340, 440. In various embodiments, the body 130, 230, 330, 430 may comprise other portions. These portions may be comprised within the body 130, 230, 330, 430 in addition to the body threaded and/or body shank portion 140, 240, 340, 440. Those skilled in the art will appreciate the various portions of which the body may be comprised.

The body portions located on the body 130, 230, 330, 430 may each have a distal end and a proximal end. In certain embodiments, the distal end may be located on an opposite side to the proximal end. In some embodiments, the body shank portion 140, 240, 340, 440 may have a body shank portion distal end and a body shank portion proximal end. In the same or other embodiments, the body threaded portion 150, 250, 350, 450 may have a body threaded portion distal end and a body threaded portion proximal end. Those skilled in the art will appreciate the variety of ends that the body portions may include after having the benefit of this disclosure.

In certain embodiments, the body shank portion distal end of the body shank portion 140, 240, 340, 440 may be located at an opposite end of the body shank portion proximal end of the body shank portion 140, 240, 340, 440. The body threaded portion distal end of the body threaded portion 150, 250, 350, 450 may be located at an opposite end of the body threaded portion proximal end of the body threaded portion 150, 250, 350, 450. In other embodiments, the body shank portion proximal end of the body shank portion 140, 240, 340, 440 may be located adjacent to the head 110, 210, 310, 410, 510, 610. In the same or other embodiments, the body shank portion distal end of the body shank portion 140, 240, 340, 440 may be located adjacent to the body threaded portion proximal end of the body threaded portion 150, 250, 350, 450. Those skilled in the art will appreciate the other relationships between different ends of the portions located on the body.

In general, the body 130, 230, 330, 430 may be measured. Those skilled in the art may find it favorable to measure the body 130, 230, 330, 430 by its circumference, total length, and portion length. Those skilled in the art will appreciate the numerous variations of measurements that one may take of the body after having the benefit of the present disclosure.

In some embodiments, the total length of the body 130, 230, 330, 430 may extend from the proximal end of the body to the distal end of the body. The total length of the body 130, 230, 330, 430 measurement may be between 72.00 mm-72.5 mm. In the same or other embodiments, the circumference of the body may be taken. The circumference of the body 130, 230, 330, 430 may be measured in a portion where the chamfered segment 146, 246, 446, 546, 846 is not located. The circumference of the body 130, 230, 330, 430 may be between 15.72 mm-16.00 mm. In the same or other embodiments, the length of the threaded portion may be taken. The length of the threaded portion may be 26.40 mm. Those skilled in the art will appreciate the endless measurement and sizes of certain portions of the bolt 100, 200, 300, 400, 600, 700.

Persons skilled in the art may appreciate a visualization of a midline. This midline may extend through the bolt. This midline may extend from the distal region of the body through the proximal region of the body. In various embodiments, the midline will be visually placed in the exact center of the body. Those skilled in the art will appreciate the various measurements, and comparisons one could make for assisting in at least the manufacturing of the bolt.

The body shank portion 140, 240, 340, 440 will now be discussed in greater detail. FIGS. 1-4 highlight examples of the body shank portion 140, 240, 340, 440, which may also be shown in other figures.

The body shank portion 140, 240, 340, 440 may be one of the portions located on the body 130, 230, 330, 430 of the bolt 100, 200, 300, 400, 600, 700. The body shank portion 140, 240, 340, 440 may comprise various other portions. In certain embodiments, these other portions may be at least one chamfered segment 146, 246, 446, 546, 846 and at least one cylindrical shank segment 142, 242, 342, 442. In various embodiments, the body shank portion 140, 240, 340, 440 may comprise one chamfered segment and two cylindrical shank segments, wherein each one of the cylindrical shank segments may be located on either side of the chamfered segment. The at least one chamfered segment 146, 246, 446, 546, 846 and at least one cylindrical shank segment 142, 242, 342, 442 will be discussed in more detail below. Those skilled in the art will appreciate the various other portions that one may include to be comprised within the body shank portion.

The body shank portion 140, 240, 340, 440 may be longer than the body threaded portion 150, 250, 350, 450. In other embodiments, the body shank portion 140, 240, 340, 440 may be of equal or lesser size than the body threaded portion 150, 250, 350, 450. Those skilled in the art will appreciate the various lengths each portion of the body may take in comparison to each portion.

The chamfered segment 146, 246, 446, 546, 846 will now be discussed in greater detail. FIGS. 1-2, 4-5 and 8 highlight examples of the chamfered segment 146, 246, 446, 546, 846, which may also be shown in other figures.

The chamfered segment 146, 246, 446, 546, 846 may be located on the body shank portion 140, 240, 340, 440 of the body 130, 230, 330, 430. In general, the chamfered segment 146, 246, 446, 546, 846 may include a substantially planar segment as well as chamfered edges 144, 244, 444. In certain embodiments, the substantially planar segment of the chamfered segment 146, 246, 446, 546, 846 will make up most of the chamfered segment 146, 246, 446, 546, 846 as a whole. The chamfered segment 146, 246, 446, 546, 846 may favorably be located on the bolt 100, 200, 300, 400, 600, 700 to increase the contact surface area 862. In some embodiments, the increased contact surface area 862 may be for receiving an aftertreatment strap 760, 860, 960 in connection with an internal combustion engine 970.

The chamfered segment 146, 246, 446, 546, 846 may be an indented segment located on one side of the body shank portion 140, 240, 340, 440. As mentioned, the chamfered segment 146, 246, 446, 546, 846 may comprise chamfered edges 144, 244, 444 for a smoother transition between the chamfered segment 146, 246, 446, 546, 846 and the rest of the body shank portion 140, 240, 340, 440. The chamfered edges 144, 244, 444 may be comprised of a chamfered edge, a fillet edge, a 90-degree edge, a bevel edge, a bullnose edge, and/or an eased edge. Those skilled in the art will appreciate the endless variations of edges between the chamfered segment and the rest of the body shank portion.

In certain embodiments, the chamfered segment 146, 246, 446, 546, 846 may be orthogonal to the top head surface 112, 712, 912 of the head 110, 210, 310, 410, 510, 610. Those skilled in the art, however, will appreciate the virtually endless angular variations between the chamfered segment 146, 246, 446, 546, 846 and the top head surface 112, 712, 912 of the head 110, 210, 310, 410, 510, 610. In various embodiments, the rear head plane provided by the rear linear head side 226, 326, 626 may be nonparallel to a receiving plane provided by the chamfered segment 146, 246, 446, 546, 846. Those skilled in the art, however, will appreciate various angular variations between the rear head plane provided by the rear linear head side and the receiving plane provided by the chamfered segment.

In general, a person skilled in the art may, for manufacturing purposes, may compare various elements of the bolt 100, 200, 300, 400, 600, 700 to other various elements of the bolt 100, 200, 300, 400, 600, 700. In one embodiment, the receiving plane provided by the chamfered segment 146, 246, 446, 546, 846 and the rear head plane provided by the rear linear side may be askew. Those skilled in the art will appreciate the various relative angular measurements between the chamfered segment and the rear linear head side.

In some embodiments, the chamfered segment 146, 246, 446, 546, 846 and at least part of the curved front head side 120, 220, 420, 620 may face generally in the same direction. In other embodiments, the chamfered segment 146, 246, 446, 546, 846 and at least part of the curved front head side 120, 220, 420, 620 may generally face different directions. Those skilled in the art will appreciate the various directions the chamfered segment and at least part of the curved front head side may face.

Although various measurements may be taken of the chamfered segment 146, 246, 446, 546, 846, those skilled in the art may find it helpful for the measurements of each section to be, instead, a range of lengths. The length of the substantially planar portion of the chamfered segment 146, 246, 446, 546, 846 may be between about 27.15 mm-27.65 mm, without limitation. The distance between the end of the substantially planar segment of the chamfered segment 146, 246, 446, 546, 846 and the bottom head surface 514 may be between about 10.05 mm-10.30 mm. Those skilled in the art will appreciate the various lengths of the substantially planar segment may be provided, without limitation. In various embodiments, the distance between the previously mentioned midline and the substantially planar segment may be about 4.98 mm-5.02 mm. Those skilled in the art will appreciate the variety of distances between the midline and the substantially planar segment.

The chamfered edges 144, 244, 444 of the chamfered segment 146, 246, 446, 546, 846 may include a radius between the planar segment of the chamfered segment 146, 246, 446, 546, 846 and the body shank portion 140, 240, 340, 440. This radius may be measured between about 2.85 mm-3.15 mm. Those skilled in the art will appreciate the various lengths of the radius between the planar segment of the chamfered segment and the body shank portion.

The cylindrical shank segments 142, 242, 342, 442 may be located on the body shank portion 140, 240, 340, 440. The cylindrical shank segments 142, 242, 342, 442 may be located above and/or below the at least one chamfered segment 146, 246, 446, 546, 846. Those skilled in the art will appreciate the endless variations of the location of the cylindrical shank segments.

The cylindrical shank segments 142, 242, 342, 442 may be fully cylindrical segments of the body shank portion 140, 240, 340, 440. In some embodiments, a cylindrical shank segment may be located at a distal end of the body shank portion. In certain embodiments, the cylindrical shank segment may be located at a proximal end of the body shank portion. Those skilled in the art will appreciate the various locations of the cylindrical shank segments.

The body threaded portion 150, 250, 350, 450 will now be discussed in greater detail. FIGS. 1-4 highlight examples of the body threaded portion 150, 250, 350, 450, which may also be shown in other figures.

The body threaded portion 150, 250, 350, 450 may be comprised of threading. This threading may favorably be used for an item, such as a nut, to be installed. Those skilled in the art will appreciate the various other objects that may be used to be screwed around or otherwise be installed the threading of the body threaded portion.

The body threaded portion 150, 250, 350, 450 may be located on the body portion adjacent to the body shank portion 140, 240, 340, 440. In certain embodiments, the body threaded portion 150, 250, 350, 450 may extend outwardly from the body shank portion 140, 240, 340, 440. As previously mentioned, in various embodiments, different portions may exist between the body threaded portion 150, 250, 350, 450 and the body shank portion 140, 240, 340, 440, without limitation. Those skilled in the art will appreciate the various organizations of the body including the different portions comprising the body after having the benefit of this disclosure.

In some embodiments, the body threaded portion 150, 250, 350, 450 may be shorter than the body shank portion 140, 240, 340, 440. However, those skilled in the art will appreciate the various lengths of the body threaded portion.

In certain embodiments, the threading of the threaded body portion may have a certain thread size. In some embodiments, the thread size of the body threaded portion 150, 250, 350, 450 may be an M16 thread. In various embodiments, the thread body portion may have a shank diameter between about 15.72 mm-16.00 mm. Those skilled in the art will appreciate the various thread sizes of the body threaded portion.

In some embodiments, the thread size of the body threaded portion 150, 250, 350, 450 may include about a 2.0 pitch. In certain embodiments, this pitch may be associated with the M16 thread size. Those skilled in the art will appreciate the various pitches of the thread sizes.

In operation, a method may be provided for reducing stress between strap applications using a novel bolt design. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

The bolt 100, 200, 300, 400, 600, 700 may have at least two key features that may be highlighted in a method of use for bolts as described herein. The first key feature may be an anti-rotation head, while the second key feature may be the mitigation of a single point of contact with regard to an installed strap.

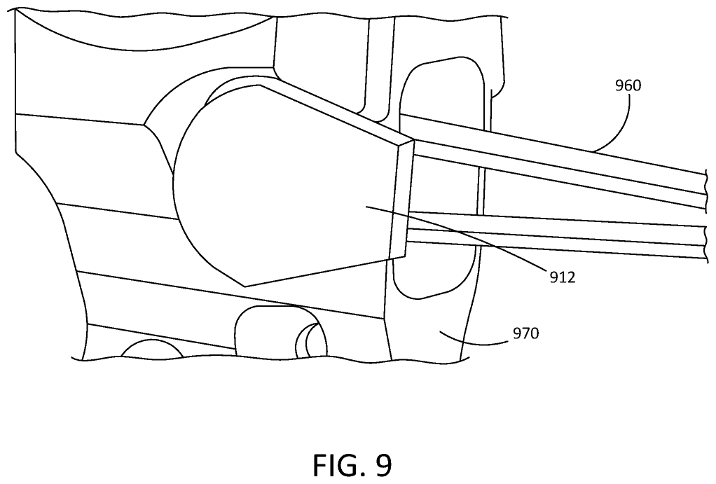

The first feature of the bolt 100, 200, 300, 400, 600, 700 will be discussed. This feature may be illustrated in at least FIG. 9, which may also be shown in the illustrations of FIGS. 1-8. The head 110, 210, 310, 410, 510, 610 of the bolt allows for stability of the entire bolt 100, 200, 300, 400, 600, 700 within an internal combustion engine 970 context. Due to the shape of the head 110, 210, 310, 410, 510, 610 as well as the shape of the internal combustion engine 970, the bolt 100, 200, 300, 400, 600, 700 may have minimal space to rotate freely, thus leading to an anti-rotation bolt. The bolt 700 may be secured in place by a compatible nut 780, without limitation.

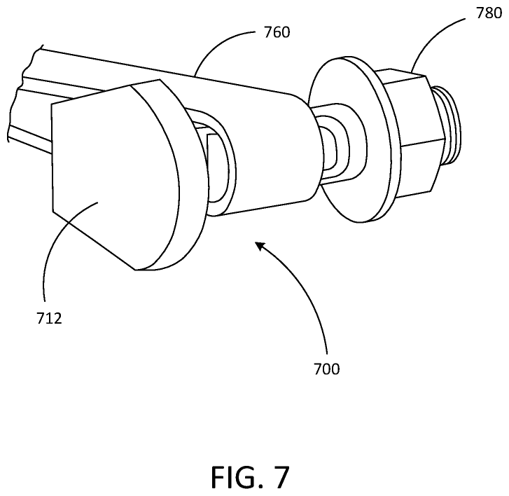

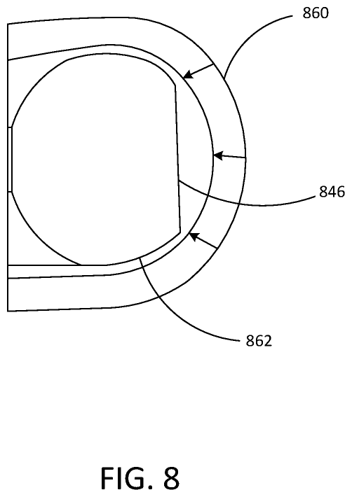

The second feature of the bolt 100, 200, 300, 400, 600, 700 will be discussed. This feature may be illustrated in at least FIGS. 7 and 8, which may also be shown in the illustrations of FIGS. 1-6 and 9. Due to the shape of the body shank portion 140, 240, 340, 440, more particularly, the chamfered segment 146, 246, 446, 546, 846, there may be an increase in contact surface area 862 between an aftertreatment strap 760, 860, 960 and the bolt 100, 200, 300, 400, 600, 700. Due to the increase of contact surface area 862, the aftertreatment strap 760, 860, 960 may have a lower likelihood of failing under pressure.

What is claimed is:

1. A bolt provided to reduce undesired rotation and to increase contact surface area comprising:
a head, further comprising:
a top head surface bounded by a rounded head edge and at least one straight head edge;
a body extending outwardly from the head, the body further comprising:
a body shank portion extending outwardly from a bottom head surface of the head, the body shank portion comprising a chamfered segment being substantially planar, and
a body threaded portion extending outwardly from the body shank portion.

2. The bolt of claim 1, wherein the head further comprises:
a curved front head side proximate to the rounded head edge,
a first linear head side adjacent to the curved front head side,
a second linear head side adjacent to the curved front head side and opposite of the first linear head side, and
a rear linear head side located between the first linear head side and the second linear head side,
wherein the rear linear head side is located opposite of the curved front head side.

3. The bolt of claim 2, wherein a rear head plane provided by the rear linear head side, a first head plane provided by the first linear head side, and a second head plane provided by the second linear head side are nonparallel.

4. The bolt of claim 2, wherein a rear head plane provided by the rear linear head side is nonparallel to a receiving plane provided by the chamfered segment.

5. The bolt of claim 3, wherein the receiving plane of the chamfered segment and at least part of the curved front head side face a first direction.

6. The bolt of claim 3, wherein the rear head plane and the receiving plane are askew.

7. The bolt of claim 1, wherein the body shank portion further comprises:
cylindrical shank segments located between the head and the body threaded portion that transition to the chamfered segment via chamfered edges.

8. The bolt of claim 1, wherein the top head surface is substantially flat.

9. The bolt of claim 1, wherein a top head plane provided by the top head surface is orthogonal to a receiving plane provided by the chamfered segment.

10. The bolt of claim 1, wherein the threaded portion is M16 thread size.

11. The bolt of claim 1, wherein the bolt is manufactured with materials comprising:
medium carbon steel, medium carbon steel alloy, and/or low carbon boron steel.

12. The bolt of claim 1, wherein the chamfered segment is configured to increase the contact surface area for receiving an aftertreatment strap used with an internal combustion engine.

13. A bolt provided to reduce undesired rotation and to increase contact surface area comprising:
a head comprising a top head surface bounded by a rounded head edge and at least one straight head edge; and
a body extending outwardly from the head comprising:
a body shank portion extending outwardly from a bottom head surface of the head,
a body threaded portion extending outwardly from the body shank portion;
wherein the body shank portion further comprises:
a chamfered segment being substantially planar, and
cylindrical shank segments located between the head and the body threaded portion that transition to the chamfered segment via chamfered edges;
wherein the body shank portion is longer than the body threaded portion.

14. The bolt of claim 13, wherein the head further comprises:
a curved front head side proximate to the rounded head edge,
a first linear head side adjacent to the curved front head side,
a second linear head side adjacent to the curved front head side and opposite of the first linear head side, and
a rear linear head side located between the first linear head side and the second linear head side and opposite of the curved front head side.

15. The bolt of claim 14, wherein a rear head plane provided by the rear linear head side, a first head plane provided by the first linear head side, and a second head plane provided by the second linear head side are nonparallel.

16. The bolt of claim 14, wherein a rear head plane provided by the rear linear head side is nonparallel to a receiving plane provided by the chamfered segment.

17. The bolt of claim 16, wherein the receiving plane of the chamfered segment and at least part of the curved front head side face a first direction.

18. The bolt of claim 16, wherein the rear head plane and the receiving plane provided by the chamfered segment are askew.

19. The bolt of claim 13, wherein the top head surface is substantially flat.

20. The bolt of claim 13, wherein a top head plane provided by the top head surface is orthogonal to a receiving plane provided by the chamfered segment.
